(19) United States
(12) Patent Application Publication
(10) Pub. No.: US 2004/0205514 A1
(43) Pub. Date: Oct. 14, 2004

(54) Hyperlink preview utility and method

(75) Inventors: Ralph Sommerer, Cambridge (GB); Robert Tucker, Cambridge (GB); Natasa Milic-Frayling, Cambridge (GB)

Correspondence Address: LEE & HAYES PLLC, 421 W RIVERSIDE AVENUE SUITE 500, SPOKANE, WA, 99201

(73) Assignee: Microsoft Corporation

(21) Appl. No.: 10/187,160

(22) Filed: Jun. 28, 2002

(51) Int. Cl. G06F 17/24

(52) U.S. Cl. 715/501.1; 715/513

(57) ABSTRACT

A hyperlink preview utility discerns user intent to display a preview of a target resource page associated with a linking control, such as a hyperlink or visit node. The preview is displayed adjacent to the linking control and may display layout and content information to a user. A preview may be displayed in a scaled down browser window. The target resource page represented by the preview may be based on a live retrieval or an archived retrieval of a previously viewed resource page. In one example, invocation of a hyperlink preview is accomplished by hovering over a hyperlink, in a manner similar to the operation for invoking a tool tip.

### RELATED APPLICATIONS

The application is related to U.S. patent application Ser. No. ______, entitled “NAVIGATING A RESOURCE BROWSER SESSION” [Docket No. MS#192137.1/40062.186US01], and U.S. patent application Ser. No. ______, entitled “RESOURCE BROWSER SESSIONS SEARCH” [Docket No. MS#192134.1/40062.184US01], both of which are specifically incorporated herein for all that they disclose and teach.

### TECHNICAL FIELD

The invention relates generally to resource browsers, and more particularly to previewing resources associated with hyperlinks.

### BACKGROUND OF THE INVENTION

The World Wide Web, and more generally the Internet, constitutes a popular communications medium. Electronic mail (“email”), web pages, and other resources can be accessed via a browser that is connected to a communications network, such as the Internet or an intranet. For example, a user can use a browser to visit a large number of web sites in various browser sessions. At each web site, a user may also visit multiple web pages during an individual browser session. Browsers can also be used to traverse a file system. Generally, browsers may be said to browse resources, whether on the Web, in a file system, or in some other type of data storage.

One method of directing a browser to visit a web page is to input an address (e.g., the Uniform Resource Locator or URL) for a desired web page into an address box of the browsers. In response to the address, the browser requests access to the web site identified by the address. A corresponding web page is returned to the browser, typically for display to the requesting user.

Another method of directing a browser to visit a web page is to use a hyperlink. Some web pages include hyperlinks to other resources. Generally, a hyperlink is an element in an electronic document that links to another location in the same document or to an entirely different document. Typically, you click on the hyperlink to follow the link to the next location. Hyperlinks are an essential ingredient of hypertext systems, such as the World Wide Web.

In a common scenario, a user accesses a current web page that includes multiple hyperlinks. For example, a user may access a web search results page having multiple links to resources identified by a web search engine. However, in order to view the resource associated with a hyperlink, the user must select the hyperlink, which causes the browser to retrieve the resource, typically replacing the current web page with the newly retrieved resource in the main browser window or raises a new browser window that completely obscures the current web page.

Losing primary view of the current web page is often undesirable for the user, particularly when the user is merely attempting to preview the resources associated with the hyperlinks on the current web page (e.g., previewing web search results). To regain primary view of the current web page, the user must instruct the browser to return to the current web page or return focus to the browser window displaying the current web page. However, such operations are relatively slow in a browser environment, particularly in a hyperlink preview type of interaction. Furthermore, managing a number of active browser windows or continuously navigating back and forth among multiple web pages while looking for desired content can be too complicated for many users.

### SUMMARY OF THE INVENTION

Embodiments of the present invention solve the discussed problems by providing a hyperlink preview utility that discerns user intent to display a preview of a target resource page associated with a linking control, such as a hyperlink or visit node. The preview is displayed adjacent to the linking control and may display layout and content information to a user. A preview may be displayed in a scaled down (or zoomed out) browser window. The target resource page represented by the preview may be based on a live retrieval or an archived retrieval of a previously viewed resource page. In one example, invocation of a hyperlink preview is accomplished by hovering over a hyperlink, in a manner similar to the operation for invoking a tool tip.

In implementations of the present invention, articles of manufacture are provided as computer program products. One embodiment of a computer program product provides a computer program storage medium readable by a computer system and encoding a computer program that previews a target resource page associated with a linking control. Another embodiment of a computer program product may be provided in a computer data signal embodied in a carrier wave by a computing system and encoding the computer program that previews a target resource page associated with a linking control.

The computer program product encodes a computer program for executing on a computer system a computer process for previewing a target resource page associated with a linking control. A preview invocation event associated with the linking control is detected. Preview content of the target resource page associated with the linking control is retrieved. A preview of the target resource page adjacent to the linking control, based on the preview content, is displayed.

In another implementation of the present invention, a method of previewing a target resource page associated with a linking control is provided. A preview invocation event associated with the linking control is detected. Preview content of the target resource page associated with the linking control is retrieved. A preview of the target resource page adjacent to the linking control, based on the preview content, is displayed.

In yet another embodiment of the present invention, a hyperlink preview utility for previewing a target resource page associated with a linking control is provided. An event monitor detects a preview invocation event associated with the linking control. A resource page downloader retrieves preview content of the target resource page associated with the linking control. A preview module displays a preview of the target resource page adjacent to the linking control.

These and various other features as well as other advantages, which characterize the present invention, will be apparent from a reading of the following detailed description and a review of the associated drawings.

### BRIEF DESCRIPTION OF THE DRAWINGS

FIG. 1 depicts an exemplary user interface for a hyperlink preview utility in an embodiment of the present invention.

FIG. 2 also depicts an exemplary hyperlink preview window in an embodiment of the present invention.

FIG. 3 depicts an alternative user interface for a hyperlink preview utility in an embodiment of the present invention.

FIG. 4A depicts exemplary operations providing a preview of a resource page targeted by a hyperlink in an embodiment of the present invention.

FIG. 4B depicts alternative exemplary operations providing a preview of a resource page targeted by a hyperlink in an embodiment of the present invention.

FIG. 5 depicts an architectural diagram of a hyperlink preview utility in an embodiment of the present invention.

FIG. 6 illustrates functionality of a navigation manager in an embodiment of the present invention.

FIG. 7 illustrates functionality of a resource page manager in an embodiment of the present invention.

FIG. 8 illustrates a resource data view of a visit in an embodiment of the present invention.

FIG. 9 illustrates two exemplary requests for a resource page in an embodiment of the present invention.

FIG. 10 illustrates processes and services of a browser session navigation tool in an embodiment of the present invention.

FIG. 11 illustrates an exemplary system useful for implementing an embodiment of the present invention.

### DETAILED DESCRIPTION OF THE INVENTION

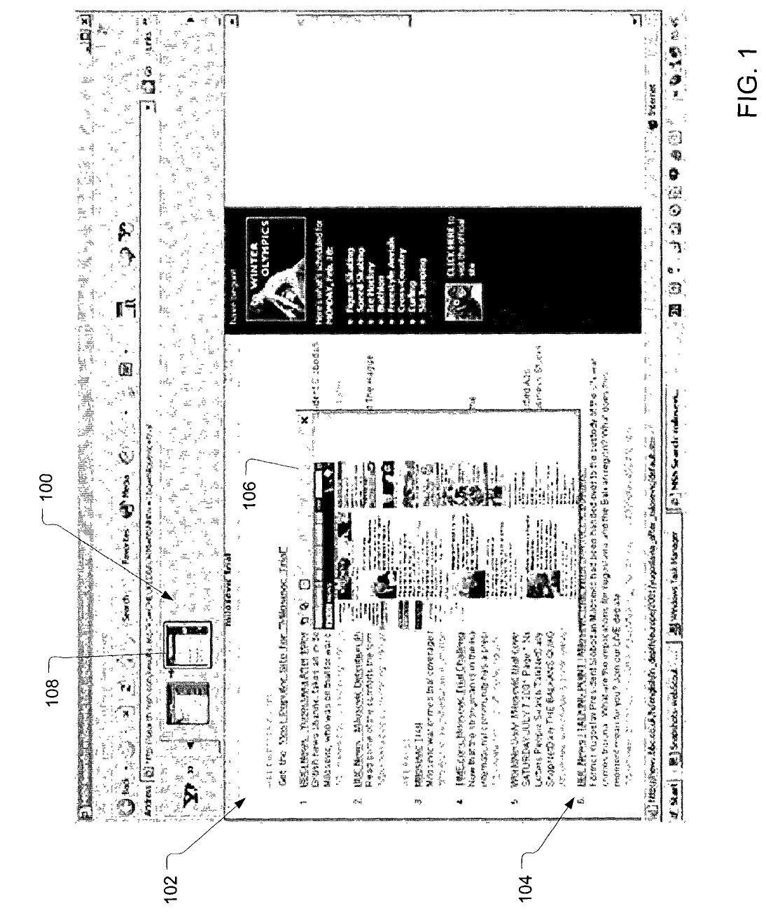

FIG. 1 depicts an exemplary user interface for a hyperlink preview utility in an embodiment of the present invention. A navigation bar 100 shows a navigation sequence of two visit nodes. The navigation bar 100 is described in more detail in related U.S. patent application Ser. No. ______[MS#192137.1/40062.0186US01], entitled “NAVIGATING A RESOURCE BROWSER SESSION.” A thumbnail image is displayed as a visit node 108 in the navigation sequence displayed in the navigation bar 100. A main window 102 displays the corresponding resource page, including multiple hyperlinks that are incorporated in the resource page. A hyperlink 104 is associated with and provides a link to another resource page, which is shown as a preview 106. It should be noted that the preview 106 does not fully obscure the resource page displayed in the main browser window, thereby allowing inspection of the previewed page's layout and content while concurrently viewing a substantial portion of the resource page.

Initially, the preview 106 is not displayed in the main browser window 102, but the user can invoke it. In one embodiment of the present invention, to invoke the preview 106, the user hovers with the mouse cursor over the hyperlink 104. In response to detecting the hovering of the mouse cursor over the hyperlink 104, the browser displays the preview 106. In an embodiment of the present invention, invocation of the preview 106 is implemented in a manner similar to that of “tool tips,” described in more detail in U.S. Pat. No. 6,281,879, entitled “TIMING AND VELOCITY CONTROL FOR DISPLAYING GRAPHICAL INFORMATION,” incorporated herein by reference for all that it discloses and teaches. In alternative embodiments, the preview 106 may be invoked by other means, including without limitation clicking on a thumbnail image (e.g., thumbnail image) of a visit node in a navigation bar or a navigation map, clicking on an icon or other control associated with a link, or selecting a hyperlink with a combination of a mouse click and a keyboard input.

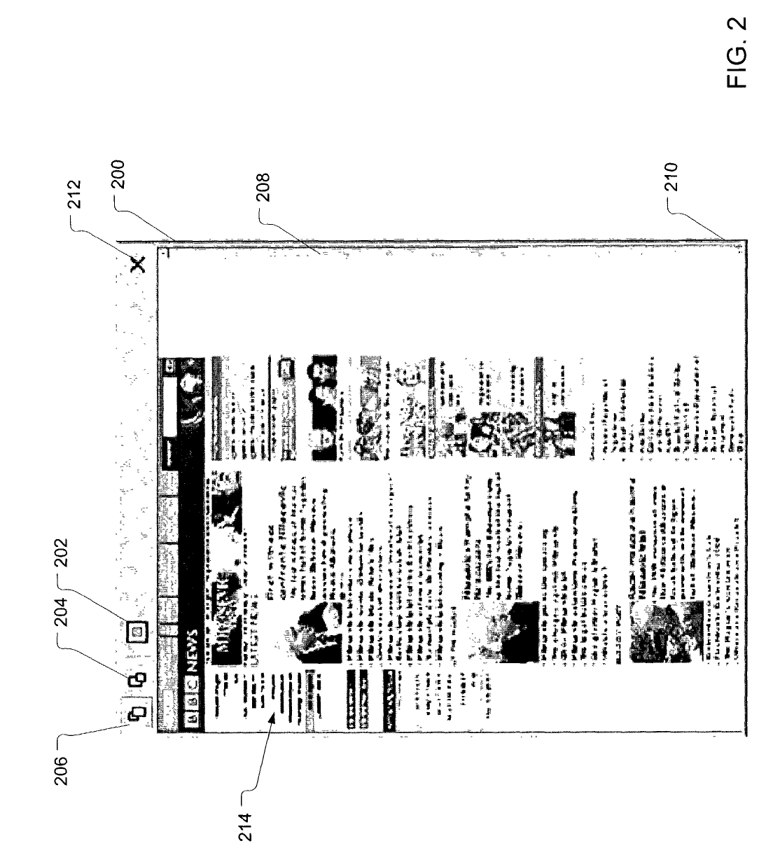

FIG. 2 also depicts an exemplary hyperlink preview window in an embodiment of the present invention. The preview 106 from FIG. 1 is enlarged as preview 200 of FIG. 2. In one embodiment, the preview 200 is displayed in a scaled down browser window and is fully functional. However, in alternative embodiments, the scaled down browser window has limited functionality, particularly with regard to user input. For example, in such an embodiment, selection of hyperlinks, input of text, and activation of controls may be prohibited. However, in such embodiments, the preview 200 is a live retrieval of the previewed resource page 214, complete with up-to-date data, advertisements, and/or animations. In some such embodiments, animation, advertisements, and audio effects may be omitted. In other embodiments, however, the preview may be a static (live or archived) thumbnail image.

In the illustrated embodiment, the preview 200 may be scrolled, using scroll bar 208, if the resource page exceeds the dimensions of the preview window. In addition, the size of the preview window may be adjusted in some embodiments by dragging a window boundary (such as boundary 210) to the desired dimension. The window for the preview 200 also includes an Increase Preview Size control 206, a Decrease Preview Size control 204, and a Highlight control 202. The Increase Preview Size control 206 enables the user to resize the preview window and its contents to a desired size. The result of enlarging the preview window is a re-rendering of the page display to fit the new dimensions of the preview window. The Decrease Preview Size control 204 provides the opposite function, reducing the preview window size. In one embodiment of the invention, a user can alternatively resize the preview window by dragging a preview window border to a desired size. The Highlighting control 202 toggles (alternatively activating and deactivating) the highlighting feature, in which the matching terms, topics, or characteristics from the last search query posed by the user are highlighted in the text of the previewed document in a manner similar to that described in U.S. patent application Ser. No. 09/578,302, filed May 25, 2000, and entitled “FACILITY FOR HIGHLIGHTING DOCUMENTS ACCESSED THROUGH SEARCH OR BROWSING” (the MS READ application). It should be understood that highlighting may include various methods of designating specific features of a preview to a user, including displaying colored fonts, coloring the background of a text, using a bold, italic, blinking or underlined font, flashing a layout characteristic (e.g., a border), flashing an image, etc.

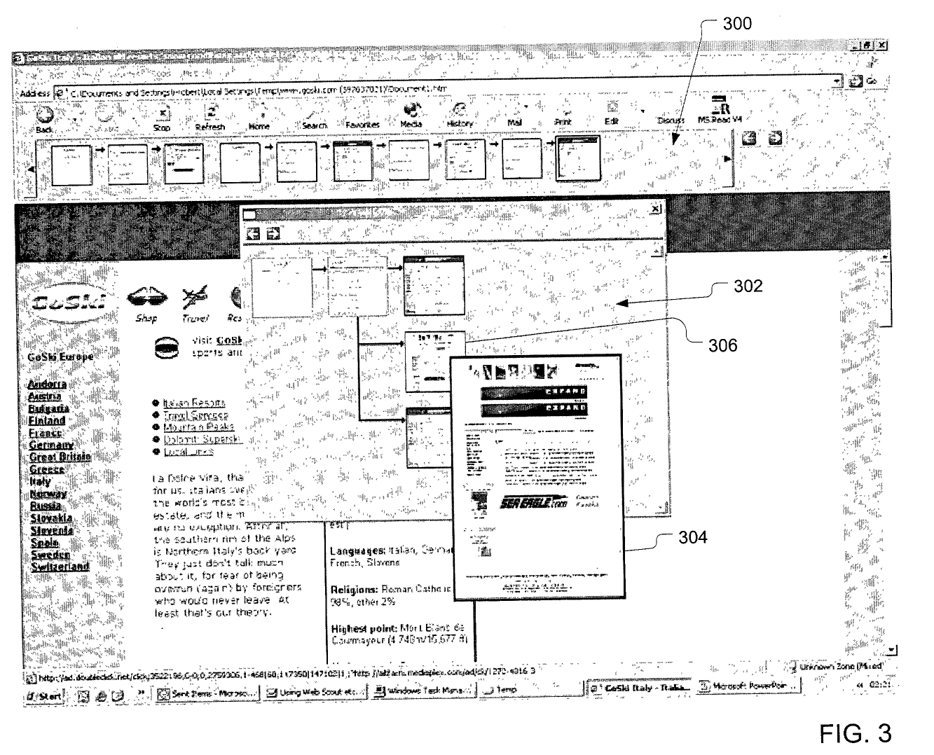

FIG. 3 depicts an alternative user interface for a hyperlink preview utility in an embodiment of the present invention. The navigation bar 300 shows a sequence of visit nodes representing the previous navigation experience of the user. In contrast, a navigation map 302 shows a hierarchical tree of visit nodes representing the previous navigation experience of the user. A preview 304 of a visit node 306 is displayed in response to user input, such as a hovering operation over the visit node 306, a selection of the visit node 306, etc. For example, the preview 304 may be involved in a manner similar to that described in more detail in the above-incorporated “tool tip” patent, U.S. Pat. No. 6,281,879, entitled “TIMING AND VELOCITY CONTROL FOR DISPLAYING GRAPHICAL INFORMATION.” It should be noted that the preview 304 does not fully obscure the visit node 306 to which it relates, thereby allowing inspection of the previewed page's layout and content while concurrently viewing a substantial portion of the visit node 306.

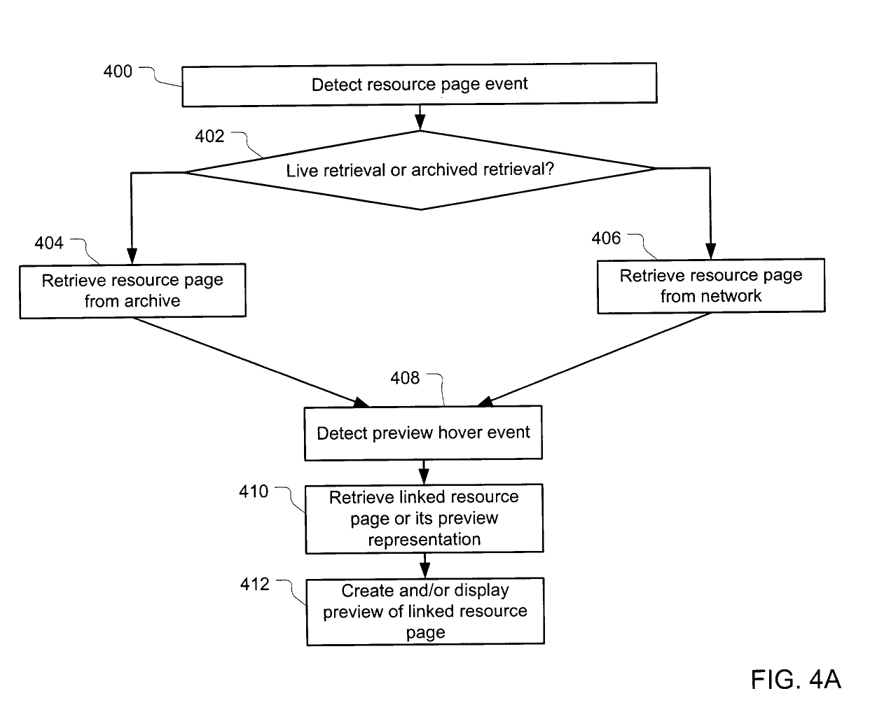

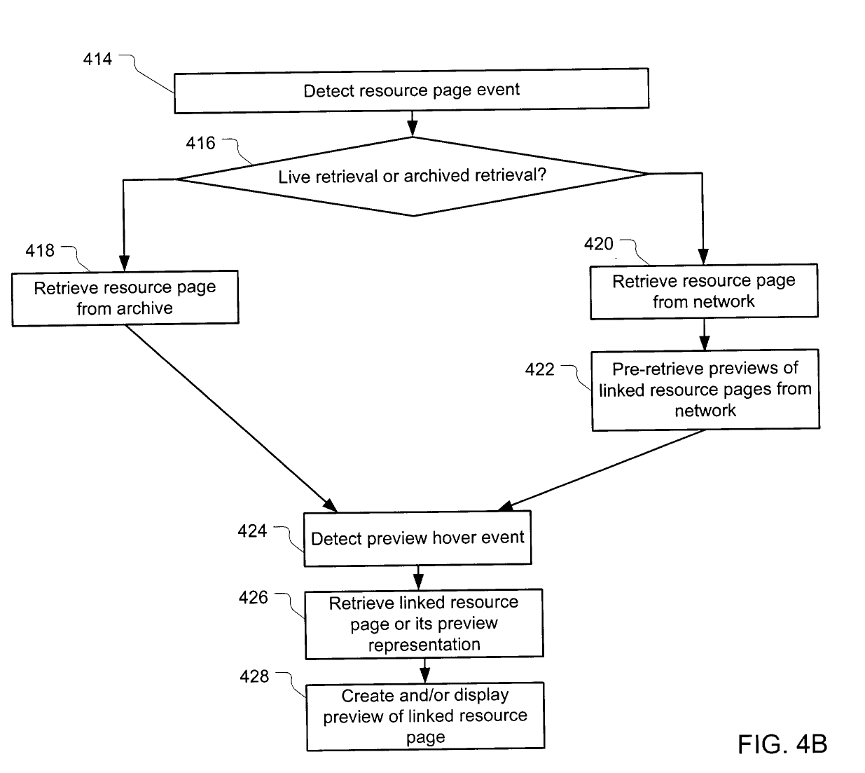

FIG. 4A depicts exemplary operations providing a preview of a resource page targeted by a hyperlink in an embodiment of the present invention. A detecting operation 400 detects a resource page event, such as an activation or “click” on a hyperlink or a submission of a Uniform Resource Locator (URL). Detection of a resource event is typically implemented through a message queue or an event handler, which receives an indication of an event (e.g., by a message, signal, or interrupt) and initiates the appropriate operations in reaction thereto. A decision operation 402 determines whether the resource page event requests a live retrieval (e.g., from a resource site on the Internet or elsewhere on a communications network) or an archived retrieval (e.g., from archive storage of previously visited resource pages). A live retrieval event results in retrieval of the resource page from the network in retrieval operation 406. An archived retrieval event results in retrieval of the resource page from the archive storage in retrieval operation 404 to The retrieved resource page is typically displayed in the main window of the browser, as shown in FIG. 1.

A detection operation 408 detects that the user has hovered the mouse cursor over a hyperlink or visit node (referred to collectively as “linking controls”). The detection of a hover event is designed to discern whether the user is intending to invoke a preview, as opposed to merely moving the cursor over a hyperlink or visit node. Detection of a preview hover event may be dependent on one or both of the timing and velocity of the hover. The hover event may be signaled by a message to an event handler or by a series of messages that satisfy given criteria. In one embodiment, a first event is detected indicating that the cursor is positioned over a hyperlink or visit node. A timer is started by the operating system or browser application. After the timer expires, a subsequent event is detected indicating that the cursor is still positioned over the hyperlink or visit node. Based on the determination that the cursor has remained over the hyperlink or visit node for the predetermined period of time, the operating system or browser application can assume that the user has intended to involve an associated preview.

Other methods of detecting a hover event are contemplated within the scope of the present invention. In an alternative embodiment, the timer is reset if a mouse location event indicates that the cursor has moved off of the hyperlink or visit node. Resetting the timer terminates detection of a hover event and prevents the display of the preview in the specific circumstance. In another alternative embodiment, both the hover delay timing and a velocity of the mouse cursor are tested to discern the user's intent to invoke display of a preview. Furthermore, as previously discussed, other user input can be used to invoke a preview, including without limitation clicking on a visit node or an associated control to show a preview. Collectively, hover events and the other user input events that invoke display of a preview are referred to as “preview invocation events.”

A retrieval operation 410 retrieves the target resource page and/or its preview representation (collectively referred to as “preview content”) from the linked resource address on the network or from archive storage, in contrast to the retrieval operations 404 or 406, which retrieved the original resource page presently displayed in the main browser window. An exemplary preview representation is a thumbnail image of the target resource page, which is created from the retrieved target resource page. If the preview content is already stored in the archive storage, the retrieval operation 410 may merely retrieve the desired preview content from the archive storage for display as a preview. In one embodiment, instead of displaying the target resource page in the main browser window, another browser window is created and the target resource page or its preview representation is displayed therein, but scaled down to provide a preview in display operation 412. The display operation 412 may also generate the preview representation of the target resource, if needed, prior to displaying it in the preview window.

The retrieval operation 410 can retrieve the preview content from multiple sources. If the target resource page has not previously been visited, it is retrieved from the network, stored in the archive storage, and displayed in a preview window. Alternatively, if the target resource page has been previously visited, it may be retrieved form the archive storage and displayed in the preview window. In one embodiment, retrieval from the archive storage may be dependent upon the context of the hover event (e.g., whether over a visit node or over a hyperlink node) or whether the target resource page has changed from the previous visit.

The retrieval operation 410 may also retrieve and store other information about the target resource page, including without limitation text summaries based on entities found in the textual content of the target resource page, associated search queries or user topics, or extracted logical units from the document (e.g., title, menus, tables of contents, paragraphs, nested documents and images, and other visual and audio characteristics). Such additional information may also be stored in the archive storage and may be used to annotate the preview. For example, if a target resource page includes an audio characteristic, such as a sound clip, the preview may be annotated with an icon indicating that the target resource page includes a sound clip. Likewise, the preview may display the title of the target resource page, if available, or the preview may be annotated with search query parameters, if appropriate. Such annotations may appear as overlays in the preview window, in an annotations section of the preview window, or in other locations associated with the preview window or main browser window.

In one embodiment, annotations based on the most recent search query appear as highlights in the preview window. In addition, the source of highlights may be a broader topic that the user may select for the annotation purpose. For example, a user may have compiled a list of names or items that the user tracks over time while using the resource. The user may simply pass the content of the file to the highlight facility. Any of the items in the list that are found in the preview content will be highlighted in the preview window. The list of topics or knowledge resources that the user may want to include for highlighting could be made accessible from the preview window interface. Furthermore, highlighting can be based on various content levels (e.g., word, phrase, sentence, paragraph, etc.), document layout elements (e.g., frames in Web pages, tables, columns, etc.), typographical elements (e.g., titles, headings, image captions, headers, footers, etc.) and document logical structure (introduction, reference list, etc.).

In addition, the style of highlighting in the preview matches the type of query. For example, if the search query reflects a user request to identify resource pages that contain images of certain color, the previewed resource page would be enhanced by highlighting those image elements on the previewed page that satisfy the same search criteria. The highlights can also be content independent but based on a given type of information (for example, types of entities such as dates, names, etc.).

In yet another embodiment, a thumbnail image may be created at web page publishing time and stored in association with the target resource page. In this embodiment, the preview utility may request only the already-generated thumbnail image from the target web server for display as a preview in the preview window. This approach minimized retrieval bandwidth and client computer cycles for each preview because the client does not need to download the entire target resource and process it into a thumbnail image.

FIG. 4B depicts alternative exemplary operations providing a preview of a resource page targeted by a hyperlink in an embodiment of the present invention. A detecting operation 414 detects a resource page event. A decision operation 416 determines whether the resource page event requests a live retrieval (e.g., from the a resource site on the Internet or elsewhere on a communications network) or an archived retrieval (e.g., from archive storage of previously visited resource pages). A live retrieval event results in retrieval of the resource page from the network in retrieval operation 420. An archived retrieval event results in retrieval of the resource page from the archive storage in retrieval operation 418. The retrieved resource page is typically displayed in the main window of the browser, as shown in FIG. 1.

A live pre-retrieval operation 422 also retrieves the target resource pages from one or more hyperlinks within the original resource page. These target resource pages are stored in the archive storage for possible retrieval from archive storage when the user invokes a preview. It is contemplated that target resource pages for one or more selected hyperlinks, and potentially all of the hyperlinks, in the original resource pages are pre-retrieved in this manner.

In yet another pre-retrieval of a target resource page is triggered by detection of the cursor in position over a hyperlink, even prior to determination that the cursor has hovered for a predetermined period of time. For example, the user may move the cursor over a few hyperlinks in the original resource page as he or she moves the cursor to a desired location on the page. Accordingly, the target resource pages linked by these hyperlinks are pre-retrieved while others are not. If the user actually hovers over one of these hyperlinks, then live retrieval of the target resource page has already started or completed and the target resource will be stored in the archive storage. In such cases, the target resource page is retrieved from the archive storage. This method limits the number of unnecessary pre-retrievals performed by the browser.

In yet another embodiment, the priority for pre-retrieval is given to hyperlinks in the currently viewed part of the page. As the user scrolls around the document, other hyperlinks are exposed and considered for pre-retrieval.

A detection operation 424 detects that the user has hovered the mouse cursor over a hyperlink or visit node. A retrieval operation 426 retrieves the preview content from the linked resource address on the network or from archive storage, in contrast to the retrieval operations 418 or 420, which retrieved the original resource page presently displayed in the main browser window. Instead of displaying the target resource page in the main browser windows, another browser window is created and the target resource page is displayed therein, but scaled down to provide a preview in display operation 428. The display operation 428 may also generate the preview representation of the target resource, if needed, prior to displaying it in the preview window.

The retrieval operation 426 can retrieve the preview content from multiple sources. If the target resource page has not previously been visited, it is retrieved from the network, stored in the archive storage, and displayed in a preview window. Alternatively, if the target resource page has been previously visited, it may be retrieved form the archive storage and displayed in the preview window. In one embodiment, retrieval from the archive storage may be dependent upon the context of the hover event (e.g., whether over a visit node or over a hyperlink node) or whether the target resource page has changed from the previous visit. The retrieval operation 426 may also retrieve and store other information about the preview content, as described with regard to retrieval operation 410 of FIG. 4A.

In the embodiment in which a target resource page is downloaded and rendered to fit the size of a scaled down browser window, no additional storage or processing of the resource is required. Similarly, if the preview representation of the target resource page already exists on the network or within the archive storage, the preview representation is merely loaded into the preview window. However, if a preview representation (e.g., a thumbnail image) is created from the target resource page content, the target resource page is downloaded from the network or retrieved from the archive storage, the preview representation is generated from the target resource page and displayed in the preview window.

In another embodiment of the present invention, a preview representation is created and stored on a proxy server to serve a community of users using the same proxy. The acceptability of the performance provided by this embodiment is dependent upon the frequency at which a particular target resource page changes. If the target resource page changes frequently, the advantage of intermediate storage of the preview representation is diminished because it is desirable to have an up-to-date preview representation available at all times. A frequently changing target resource page may require frequent updates to the intermediate storage of the preview representation, even if attempted previews to this target resource page are infrequent.

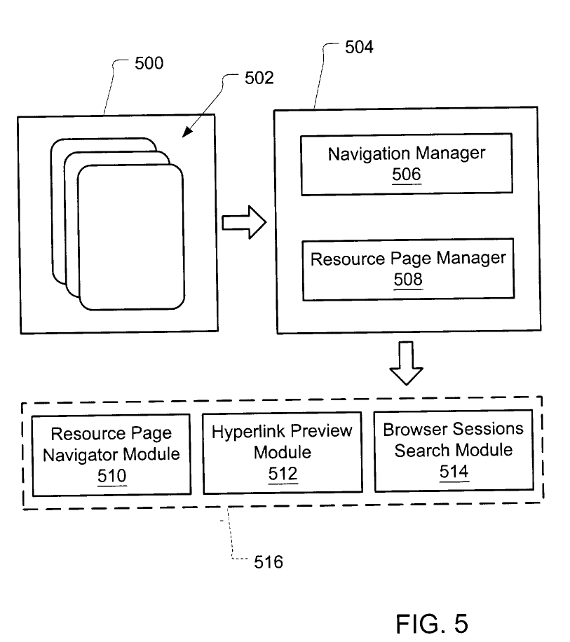

FIG. 5 depicts an architectural diagram of a hyperlink preview utility in an embodiment of the present invention. A browser 500 (e.g., a web browser) displays resource pages 502 (e.g., web pages, files, directories, computers, etc.) in a main browser window. Browser and user interface events from active browser windows are communicated from the browser 500 to underlying services 504 to effect browser sessions search functionality.

One such service is a navigation manager 506, which creates and stores the rich record of a user's navigation during a browser session. In one embodiment, the navigation record includes information regarding navigation events and objects, including the type and time stamp of a navigation event, local and remote references to objects (e.g., URLs and local paths to of resource pages), and any metadata associated with the navigation (e.g., search queries, user annotations, device or environment specific parameters, etc.). The navigation record is stored, in part, for use in displaying various views (such as a trail or a map) of the navigation during a browser session.

Another such service is a resource page manager 508, which performs loading and analyses of the resource pages accessed through the browser 500. The types of analysis can include without limitation page layout analysis, text content processing, thumbnail image creation, and color scheme analysis.. The resource page manager 508 also manages storage of archive data so that other modules 516 can access, further analyze, and present the analysis to the user in various forms. For example, a resource page navigator module 510 accesses the archive data to present the browser session navigation bar and/or map views to the user. The resource browser session navigation functionality is described in further detail in U.S. patent application Ser. No. ______, entitled “NAVIGATING A RESOURCE BROWSER SESSION” [Docket No. MS#192137.1/40062.186US01].

Another module may perform a thumbnail color analysis in a browser sessions search module 514 to allow a user to search a page with a specific color characteristic and/or another visual aspect. As the resource browser generates visit data structures for each visit to a resource page, each visit data structure may be annotated with the results of text analysis, color scheme analysis, layout analysis, natural language analysis, navigation analysis, metadata analysis, page elements analysis, and other types of resource page analysis. For example, as a result of one or more of these analyses, a user may use the browser sessions search module 514 to search for all previously visited resource pages navigated from a designated resource page containing a designated shade of the color red.

Yet another module may include a hyperlink preview module 512 to allow a user to preview a resource page associated with a hyperlink or visit node in a miniature preview window.

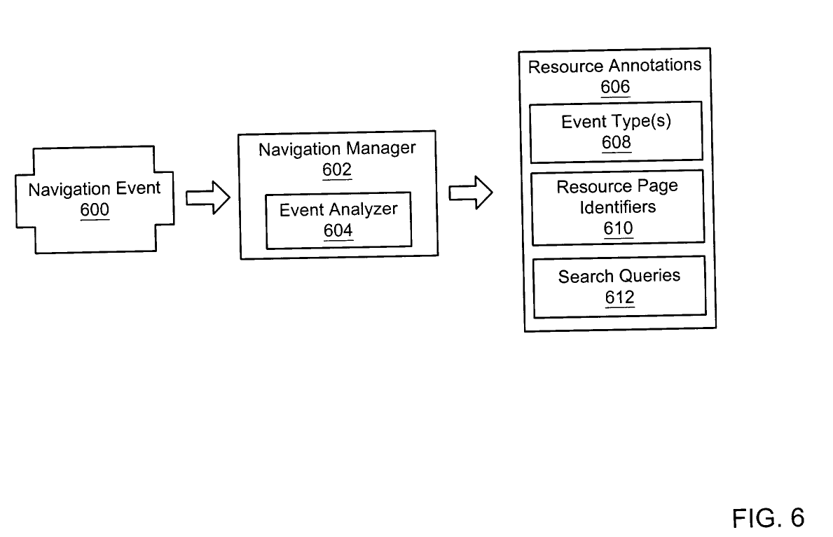

FIG. 6 illustrates functionality of a navigation manager in an embodiment of the present invention. A navigation event 600 is detected by the navigation manager 602 (e.g., receiving a navigation event in an event handler). In one embodiment, the navigation event 600 may include without limitation:

(1) a resource page access event caused by providing a URL for a resource (e.g., in an address bar);

(2) a resource page access event caused by selection of a hyperlink within the browser;

(3) a resource page access event caused by execution of a search query (e.g., via a search engine web page) or a request to access an on-line service (e.g., logging into a service site, etc.);

(4) a resource page access event caused by selection or execution of a hyperlink from another application (e.g., from an e-mail message or other document type);

(6) a resource page access event caused by selection of the Back/Forward navigation features in a browser; or

(6) a resource page access event caused by selection of a resource identifier from a list of recently accessed resources (e.g., via a standard history list or Favorites list).

However, in one embodiment of the present invention, live navigation events result in addition of one or more new visit nodes in a trail or map, whereas non-live navigation events do not. For example, navigation events that result in an access to a live resource page, such as an execution of a link on a page, cause an addition of a new visit node to a trail or map. Similarly, an explicit HTTP (Hypertext Transfer Protocol) request for retrieving a live web page can result in creating a whole new trail, including the requested page thumbnail as the first node. In contrast, using the back/forward features of a browser to traverse through previously visited nodes results in access to an archived (non-live) resource page and, therefore, does not result in an addition to a trail or map. In another embodiment, when a back/forward feature is used to traverse to a previously visited node and the user executes a live navigation from the previously visited node to a new node, both a duplicate of the previously visited node and the new visit node are added to the trail, but only the new node is added to the map, on a new branch. Furthermore, if the user accesses an archive page in one of the previous trails and navigates away by executing a link on the archived page, a new trail is started by creating the reference (a thumbnail image) of the re-visited page and the newly accessed page. In yet another embodiment, all navigation events result in additions to the trail, even those caused by archive retrievals.

When an event is triggered or accompanied by a web search query or a user selected topic, that event is analyzed by an event analyzer 604 and the corresponding resource page (e.g., the search result page and/or the search engine page) is annotated by the query or the topic to facilitate revisiting of the search result page or the resource page associated with the topic. For example, a page may be annotated (see event annotations 606) with one or more relevant event types 608, including without limitation: hyperlink selection, open in new window, form submission (which includes a query), back/forward, selection from favorites, selection from history, selection from address bar list, browsing to a URL typed into the address bar, pop-up windows, and auto-refresh. Furthermore, a page may also be annotated with resource page identifier(s) 610 (e.g., a URL, a user-selected topic or a user specified label) or web search query terms 612 corresponding to either the page or the event.

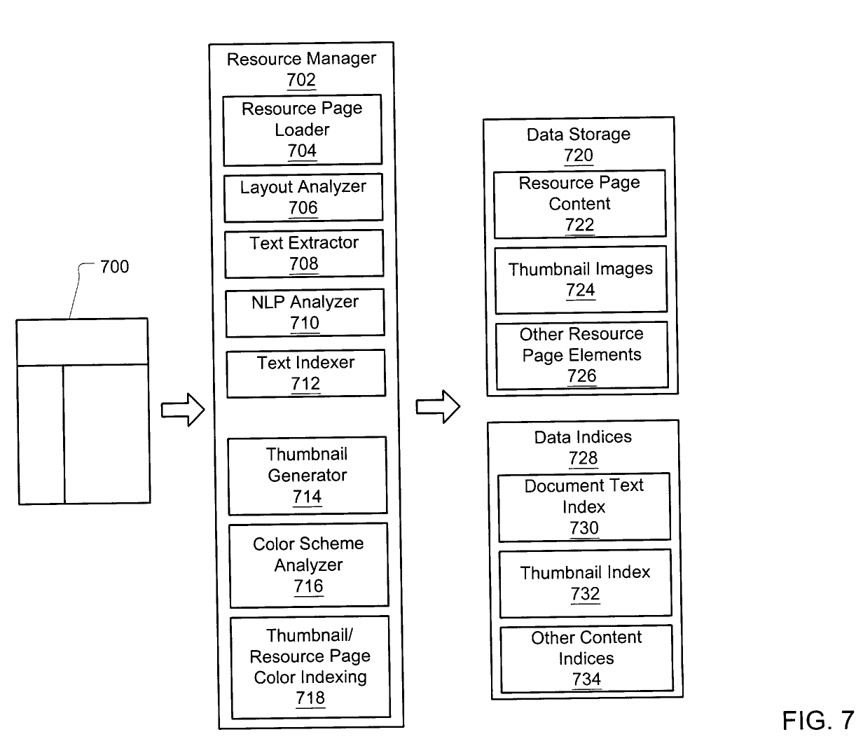

FIG. 7 illustrates functionality of a resource page manager with respect to the accessed resource page content in an embodiment of the present invention. When a resource page 700 (depicted as a web page having three component web documents separated by frames) is received by the browser, the resource page includes at least one resource page identifier and a time stamp. In the exemplary resource 700, the three component documents are identified by individual URLs. A resource page manager 702 processes resource pages that are loaded by the browser, using one or more internal modules to accomplish such processing.

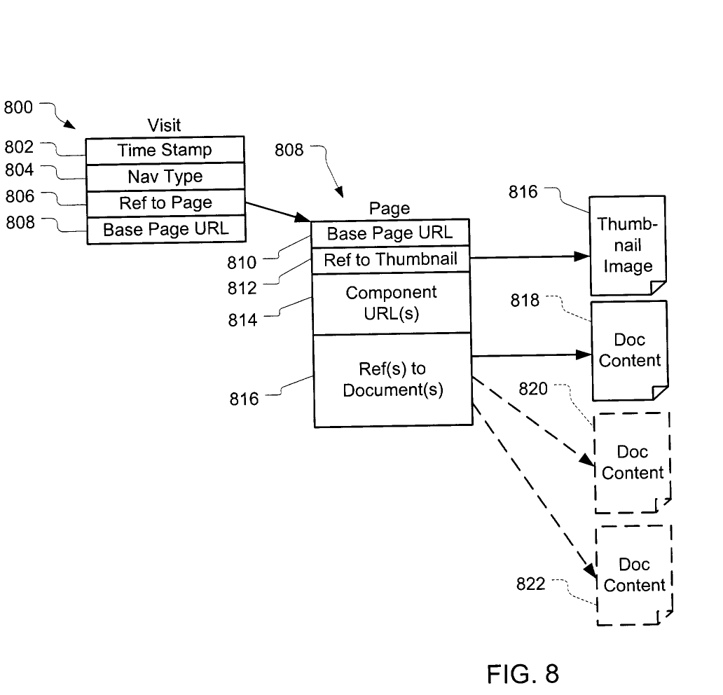

A resource page loader module 704 captures a view of the resource page 700, storing the resource page content, including multiple documents of multi-frame page layouts, into the resource page content portion 722 of the data storage 720. See the exemplary visit and page data structures of FIG. 8 for more detail.

A layout analyzer module 706 analyzes and stores various logical components of the resource page (e.g., component images and links associated with banner advertisements). The layout analyzer module 706 identifies characteristics of the document and object within the document that would be exposed to a user (such as elements that the user can search or view independently). The layout analyzer module 706 analyzes the layout of the viewed resource page and the geometric characteristics of the rendered display of the resource page. For some web pages, for example, the layout analyzer module 706 analyzes the HTML document object model (DOM). The analysis determines the logical structure of the resource page, including the identification of elements that the user may wish to search on or browse through, such as titles, menus, advertisements, images, hyperlink anchor text, etc.

A text extractor module 708 extracts the text from the resource page 700 using known lexographical and parsing techniques. A natural language processing (NLP) analyzer module 710 examines the extracted text and may include one or more linguistics tools, ranging without limitation from a simple stemming tool to a deep syntactic and semantic analysis tool, depending on the performance requirements (i.e., speed and accuracy). For example, for simple highlighting of text in a document, segmenting text into sentences and words may be sufficient. In contrast, for summarizing a document, a complete syntactic and semantic analysis may be applied. Text analysis results may be persisted in the resource page content portion 722 of data storage 720, such as metadata in XML (eXtensible Markup Language), another Web publishing format, or even a more general publishing format.

The extracted text is indexed by a text indexing module 712, which stores information lo about the resource page that will be used for retrieving the document. In one embodiment, indexing for standard information retrieval (IR) is employed, although in another embodiment, additional features are implemented. For example, indexing is performed to take into account the structure and logical units of the document content, such as indexing on the anchor text of the hyperlinks, URLs, image captions, headings, etc. The text indices are stored in the document text index portion 730 of the data indices storage 728 to facilitate text searching and resource page retrieval. Generally, the type of index is determined by the type of resource in use. For example, if a resource is a structured set of equipment, an appropriate index may consist of a simple list of resource identifiers and equipment names or similar user-recognizable labels.

A thumbnail generator module 714 creates a thumbnail image from the resource page 700 and stores the thumbnail image in the thumbnail images portion 724 of the data storage 720. The thumbnail generator module 714 captures the image rendered by the browser. Thumbnail images may be created by capturing a snapshot image from the browser contents, which is then scaled down to an appropriate thumbnail size by computing for every thumbnail pixel an average color for the corresponding region of the original browser snapshot image.

A color scheme analyzer module 716 analyzes the thumbnail and/or color scheme of the resource page 700. Color schemes of the resource page 700 can be captured by analysis of the resource page representation. For example, if the resource page 700 is a web page, the color scheme can be captured by analysis of the HTML document that defines the web page, such as by counting the number of pixels of each color in a given region of the web page.

A thumbnail/resource page color indexing module 718 indexes the analyzed thumbnail and/or color schemes and stored the indices in the thumbnail image index portion 732 and the other content indices portion 734 of the data indices storage 728 to facilitate searching. The color information extracted by the color scheme analyzer module 716 is stored in a searchable index, where a search may be conducted by “query by example or filtering of the result based on the position of the search color on the resource page. For example, if the user remembers that a dark green banner advertisement was located at the top of a previously viewed web page, the user may search for the dark green color at the top of a web page, based on appropriate search criteria input.

FIG. 8 illustrates an exemplary resource data view of a visit in an embodiment of the present invention. A visit data structure 800 represents a visit node in a trail or a map. For each navigation event that results in a visit node, a visit data structure 800 is created and added to the trail or map. A time stamp value 802 specifies the time the navigation event was detected. The “nav type” value 804 specifies the type of navigation event (e.g., back, forward, hyperlink, URL entry, etc.). Note: “Nav types” are described as “event types” with regard to the discussion of FIG. 6. On the basis of these Nav types, navigation sequences associated with a given visit data structure may be dynamically reconstructed. A “ref to page” value 806 specifies a reference (e.g., pointer) to a page data structure (such as page data structure 808) that defines the resource page visited.

In one embodiment, a unique visit identifier 807 is also stored in the visit data structure 800. A unique visit identifier incorporates a signature that uniquely identifies the contents of the accessed resource page and is relevant in cases when the resource changes with time and the storage of the newly retrieved, if only slightly changed, resource page content is required. The signature is used to verify whether the whole accessed page or any component thereof has previously been retrieved and stored in the archive for reuse. A unique signature is generated for each archived resource page, or for individual constituent parts of each resource page. Comparison of content signatures enables optimization of the storage space and archival management (e.g., by eliminating pages or constituent parts thereof that were previously accessed and archived but do not significantly differ from the resource page target of the current navigation request). Exemplary signatures may include without limitation time stamps, hash keys, encryption keys, or serialized forms of such resources and constituent parts.

In the page data structure 808, a base page URL value 810 specifies the location of the resource page (note that the URL value may, for example, also specify a pathname in a local file system). The base page URL value 810 identifies the resource page location. A “ref to thumbnail” value 812 references a thumbnail image 816, which is displayed in the visit node of a trail of the browser session navigation bar or a tree of the browser session navigation map. In one embodiment, the reference to the thumbnail image 816 is a local pathname into the thumbnail content portion of the archive data storage. References to such resource pages, resource page locations, and thumbnail images allow the tool to reuse duplicative data storage. For example, repeated visits to the same web site can result in the reuse of the archived web page content, URL, and thumbnail image, merely by referencing the existing archive storage for these elements.

If there are multiple resource documents in the base resource page (e.g., in a multi-frame web page), the component URL values 814 are listed in the page data structure 808. The component URL values 814 specify the location(s) of the component resource document(s) of the resource page. The page data structure also includes one or more references 816 to the base resource document storage 818 and component resource document stores 820 and 822. It should be understood that document content stores 820 and 822 are shown using dashed lines to indicate lo that, in some configurations, only a single document content storage is referenced. In one embodiment, the references to the document content stores 816, 820, and 822 are local pathnames into the resource page content portion of the archive data storage.

Each visit data structure is navigationally related with other visit data structures, as indicated by the “nav type” value 804. The visit data structures are stored in a set of visit data structures for a browser session, such as in a linked list. In addition, a new visit data structure is added to the set of visit data structures upon each navigational event, although for non-live retrievals, a new page data structure need not be created. Instead, a new visit data structure is created and added to the list of visits in the browser session, and the new visit data structure merely references the previously retrieved page data structure. Furthermore, creation of a new visit data structure does not require creation of a new visit node in either the browser session navigation bar or the browser session navigation map.

Moreover, it is also common for one document in a multi-frame page to change without other documents in the same page changing. For example, by selecting a bookmark in a table of contents of one frame, the document in the other frame may change to display the selected chapter. In such circumstances, a new visit data structure and a new page data structure are created, but the unchanged component document content stores (e.g., the table of contents document) are merely referenced by the new page data structure without duplicating the document content storage. The changed component document content, however, is created by the resource page manager, stored in the resource page content portion of archive data storage, and referenced from the new page data structure.

Annotations can be created and stored on many different levels, including without limitation at a visit level, with any constituent part of the resource content associated with the visit, at a page level (i.e., the Web location referred to by the URL), with a sequence of pages (e.g., a trail or other derived sequence or set of pages), and at a session level (e.g., in association with an identified browser session). Visual representations (e.g., thumbnails) and content analysis results relating to a resource are represented as annotations on the visit level, although other levels are also contemplated within the scope of the present invention. Such annotations may be stored in the visit data structure or directly in the data structures associated with services that use these annotations (e.g., into a searchable index of the various search services). With such storage, in one embodiment of the present invention, the logical connection with the visit is maintained via URL and the time stamp, although other logical connections may be employed within the scope of the present invention.

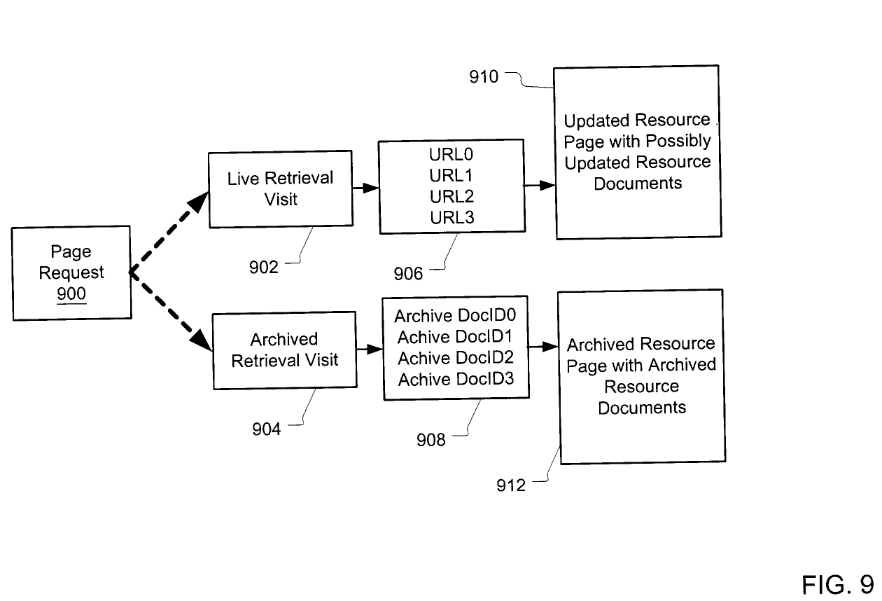

FIG. 9 illustrates two exemplary requests for a resource page in an embodiment of the present invention. A page request 900 is a navigation event requesting a resource page. In the example, the request 900 results in a live retrieval of the resource page. Accordingly, a visit data structure 902 for a live retrieval visit is created and populated with the time stamp for the event, a nav type value and a reference to a page data structure 910.

In one implementation, the navigation information is captured and managed by the navigation manager and stored separately from the visit information. The logical correspondence to the visit data in maintained via URL and time stamp. An alternative embodiment stores navigation information within the visit data structures. Furthermore, navigation sequences, such as trails, are derived by analyzing the navigation record and may be created on demand. Alternatively, a navigation sequence may be stored for efficient presentation to the user, such as in associations or sequences of visit data structures or references to visit data structures.

In addition, stored navigation sequences may be annotated by the user, so as to label or bookmark the sequence for later recall. For example, a stored navigation sequence may be labeled “My Financial Page Review” and be stored or bookmarked. Thereafter, the user can recall the sequence to examine the archived information in greater detail. Alternatively, the user can annotate the sequence such that the order and URLs of the pages (of other pointers to the live resource pages) in the sequence is preserved, but the content of each page is updated with a live retrieval. Stored navigation sequences can be edited (i.e., deletion of a visit) and re-saved under a different sequence identifier or label. Saved sequences may also be emailed (e.g., by attachment) to other users.

As a live retrieval, the resource page is retrieved from its resource location based on the base URL (e.g., URL0), which was specified in the page request 900 (e.g., by a hypertext link selection, by an HTTP request submission that generates a result page URL, etc.). In an alternative embodiment, the resource page manager may determine that the requested live resource is unchanged from a previous visit, although this functionality may be configurable. Page signatures may be used to determine if the resource page has changed. If the resource page manager determines that the base resource document is unchanged from a previous visit, the reference to the base resource document in the page data structure 910 merely points to the previous instance of the resource page document in the archive data storage. Otherwise, the newly retrieved base resource page document is recorded in the archive and referenced by the page data structure 910 in the archive, which is in turn referenced by the visit data structure 902. In one embodiment, the page data structure 910 references the base resource page document using document identifiers (e.g., DocID0), which may take various forms, including without limitation file system path names or Globally Unique Identifiers (GUIDs). If the base URL specifies the only document in the requested resource page, then no component resource documents need to be processed or stored in the page data structure 910.

If the base URL specifies a resource document having component resource documents, then the page loader also retrieves the component resource documents based on the component URLs (e.g., URL1-URL3) specified in the resource document of the base URL. Again, the resource page manager may determine that the live component resource documents are unchanged from a previous visit, although this functionality may be configurable. If the resource page manager determines that one or more of the component resource documents are unchanged from a previous visit, references to the component resource documents merely point to the previous instances of the component resource documents in the archive data storage. Otherwise, the newly retrieved component resource documents are recorded in the page data structure 910 in the archive, which is referenced by the visit data structure 902.

The resource page manager generates a thumbnail image of the resource page (including the base resource document and any component resource documents), stores the thumbnail image in the thumbnail images portion of the archive data storage, and inserts the reference to the thumbnail image into the page data structure 910.

In contrast, if the request 900 results in retrieval of a resource page from the archive, there may be no need for a live retrieval of any resources. For example, a user may use the Back feature to return to the previously viewed resource page in the navigation sequence. Accordingly, a visit data structure 904 for an archived retrieval visit is created and populated as a near duplicate of the previously created visit having its own time stamp for the visit event, its own nav type value (e.g., “BACK”), and a duplicated reference to a page data structure 912. As an archived retrieval, the resource page documents are merely referenced in the archive. In one embodiment, the page data structure 912 references a base archived resource document using a base document identifier (e.g., DocIDO). Likewise, any component resource documents are also referenced from the page data structure. The thumbnail image of the resource page (including the base resource document and any component resource documents) are also referenced from the page data structure 912.

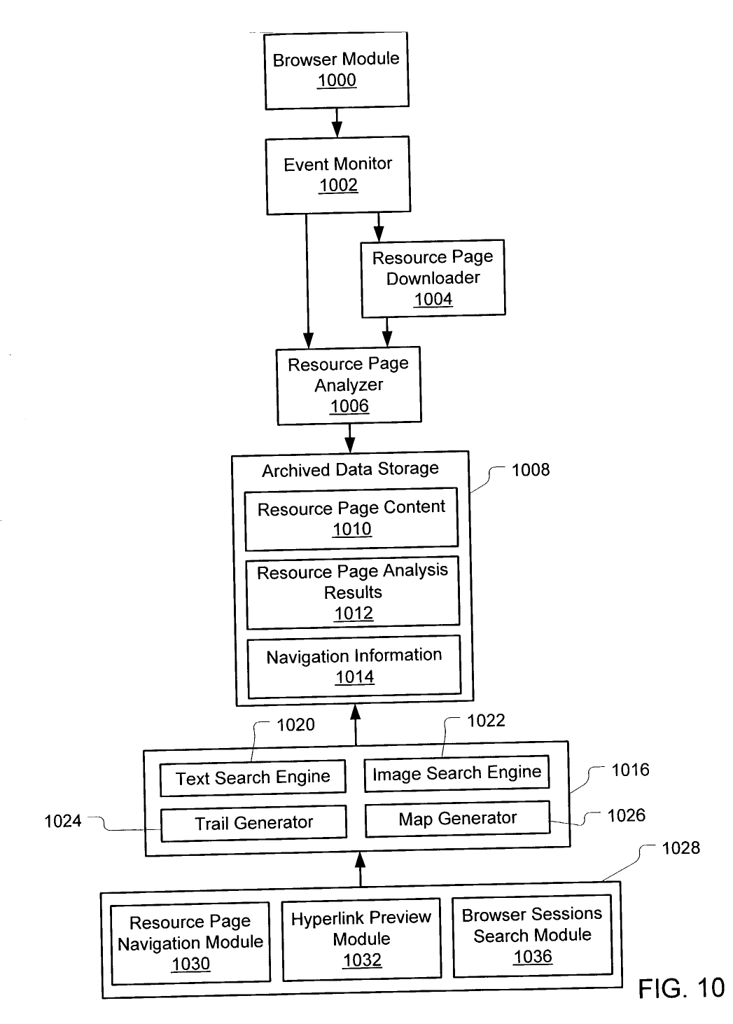

FIG. 10 illustrates processes and services of a browser session navigation tool in an embodiment of the present invention. A browser module 1000 receives user input or network communications that result in a navigation event. An event monitor 1002 in the navigation manager detects the navigation event. If the browser is invisible, the resource page associated with the navigation event is downloaded by the resource page downloader 1004 before page analysis by the resource page analyzer 1006. Otherwise, if the browser is visible, page analysis is performed without downloading by the resource page downloader 1004. Note: in one embodiment, an “invisible” browser is used in the implementation of thumbnail creation, although in other embodiments the use of “invisible” browsers may not be required.

The resource page analyzer 1006 in the resource page manager captures the resource page content and creates a thumbnail image for use in a navigation bar or map. In addition, the resource page analyzer 1006 is also capable of performing layout and logical structure analysis, which can be used in history searches.

The event monitor 1002 and the resource page analyzer 1006 store the resource page content, various resource identifier, the thumbnail image, various indices, analysis results, and navigation event information in the archived data storage 1008. The resource identifiers, resource page content and thumbnail images are stored in the resource page content portion 1010 of the archived data storage 1008. The indices and other analysis results are stored in the resource page analysis results portion 1012 of the archived data storage 1008. The navigation event is stored in the navigation information portion 1014 of the archived data storage 1008.

Several services 1016 can access the archived data storage 1008 to service features 1028, such as a resource page navigation module 1030, a hyperlink preview module 1032, and a browser sessions search module 1034. Each feature 1028 uses the one or more services 1016 to obtain browser session navigation information. A text search engine service 1020 processes text search queries from the resource page navigator module 1030 and the browser sessions search module 1034. Likewise, an image search engine service 1022 processes color and visual aspect search queries from the resource page navigator module 1030 and the browser sessions search module 1034. A trail generator 1024 processes and provides data for display of visit trails. A map generator 1026 processes and provides data for display of visit trees.

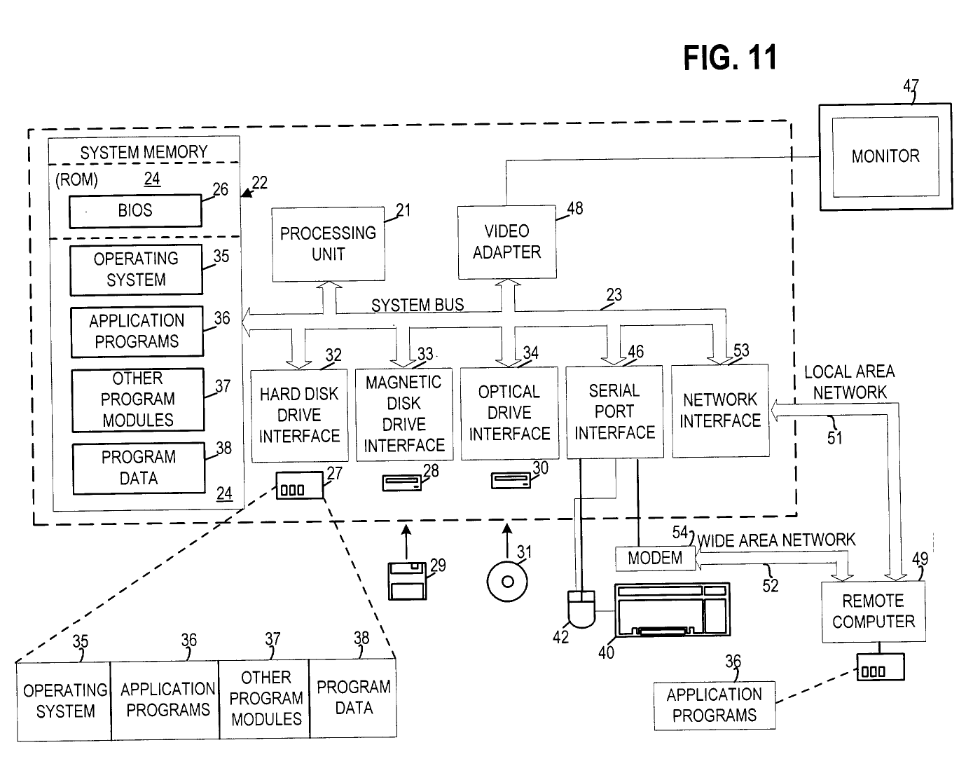

The exemplary hardware and operating environment of FIG. 11 for implementing the invention includes a general purpose computing device in the form of a computer 20, including a processing unit 21, a system memory 22, and a system bus 23 that operatively couples various system components include the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that(help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 11. The logical connections depicted in FIG. 11 include a local-area network (LAN) 51 and a wide-area network (WAN) 52. Such networking environments are commonplace in office networks, enterprise-wide computer networks, intranets and the Internal, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internal. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

In an embodiment of the present invention, a hyperlink preview utility of the present invention, including the resource page manager, the navigation manager, the resource page navigator module, the browser sessions search module, and the hyperlink preview module may be incorporated as part of the operating system 35, application programs 36, or other program modules 37. The visit data structures, page data structures, and content data stores associated with the navigation tool may be stored as program data 38.

The embodiments of the invention described herein are implemented as logical steps in one or more computer systems. The logical operations of the present invention are implemented (1) as a sequence of processor-implemented steps executing in one or more computer systems and (2) as interconnected machine modules within one or more computer systems. The implementation is a matter of choice, dependent on the performance requirements of the computer system implementing the invention. Accordingly, the logical operations making up the embodiments of the invention described herein are referred to variously as operations, steps, objects, or modules.

The above specification, examples and data provide a complete description of the structure and use of exemplary embodiments of the invention. Since many embodiments of the invention can be made without departing from the spirit and scope of the invention, the invention resides in the claims hereinafter appended.

What is claimed is:

1. A computer program product encoding a computer program for executing on a computer system a computer process for previewing a target resource page associated with a linking control, the computer process comprising:
detecting a preview invocation event associated with the linking control;
retrieving preview content of the target resource page associated with the linking control; and
displaying a preview of the target resource page adjacent to the linking control, based on the preview content.

2. The computer program product of claim 1 wherein the preview includes a preview representation of the target resource page.

3. The computer program product of claim 2 wherein the preview representation includes a thumbnail image of the target resource page.

4. The computer program product of claim 2 wherein the computer process further comprises:
generating the preview representation of the target resource page for display as the preview of the target resource page.

5. The computer program product of claim 1 wherein the preview includes content of the target resource page.

6. The computer program product of claim 1 wherein the computer process further comprises:
retrieving a first resource page including the linking control.

7. The computer program product of claim 6 wherein the computer process further comprises:
displaying the first resource page in a browser window.

8. The computer program product of claim 6 wherein the computer process further comprises:
retrieving the preview content of the target resource page prior to completion of the detection operation.

9. The computer program product of claim 1 wherein the operation of retrieving preview content of the target resource page associated with the linking control comprises:
retrieving the preview content of the target resource page from a network.

10. The computer program product of claim 1 wherein the operation of retrieving preview content of the target resource page associated with the linking control comprises:
retrieving the preview content of the target resource page from an archive storage.

11. The computer program product of claim 1 further comprising:
archiving the retrieved preview content of the target resource page.

12. The computer program product of claim 1 wherein the linking control is a hyperlink.

13. The computer program product of claim 12 wherein the operation of displaying the preview comprises:
retrieving and displaying a first resource page including the linking control.
displaying the preview of the target resource page adjacent to the linking control such that the preview does not fully obscure display of the first resource page.

14. The computer program product of claim 1 wherein the linking control is a visit node.

15. The computer program product of claim 1 wherein the preview includes layout and content of the target resource page.

16. The computer program product of claim 16 further comprising:
displaying the preview in a scaled down browser window.

17. The computer program product of claim 1 wherein the detecting operation comprises:
detecting a cursor hovering over the linking control for a predetermined period of time.

18. The computer program product of claim 1 wherein the retrieving operation comprises:
retrieving the preview content from an archive storage of one or more previously visited resource pages.

19. The computer program product of claim 1 wherein the displaying operation comprises:
highlighting one or more aspects of the preview based on a previous search query.

20. The computer program product of claim 1 wherein the displaying operation comprises:
highlighting one or more terms displayed in the preview based on a previous search query.

21. The computer program product of claim 1 wherein the displaying operation comprises:
highlighting one or more aspects of the preview based on a user defined topic.

22. A method of previewing a target resource page associated with a linking control, the method comprising:
detecting a preview invocation event associated with the linking control;
retrieving preview content of the target resource page associated with the linking control; and
displaying a preview of the target resource page adjacent to the linking control, based on the preview content.

23. The method of claim 22 wherein the preview includes a preview representation of the target resource page.

24. The method of claim 23 wherein the preview representation includes a thumbnail image of the target resource page.

25. The method of claim 23 further comprising:
generating the preview representation of the target resource page for display as the preview of the target resource page.

26. The method of claim 22 wherein the preview includes content of the target resource page.

27. The method of claim 22 further comprising:
retrieving a first resource page including the linking control.

28. The method of claim 27 further comprising:
displaying the first resource page in a browser window.

29. The method of claim 27 further comprising:
retrieving the preview content of the target resource page prior to completion of the detection operation.

30. The method of claim 22 wherein the operation of retrieving preview content of the target resource page associated with the linking control comprises:
retrieving the preview content of the target resource page from a network.

31. The method of claim 22 wherein the operation of retrieving preview content of the target resource page associated with the linking control comprises:
retrieving the preview content of the target resource page from an archive storage.

32. The method of claim 22 further comprising:
archiving the retrieved preview content of the target resource page.

33. The method of claim 22 wherein the linking control is a hyperlink.

34. The method of claim 33 wherein the operation of displaying the preview comprises:
retrieving and displaying a first resource page including the linking control.
displaying the preview of the target resource page adjacent to the linking control such that the preview does not fully obscure display of the first resource page.

35. The method of claim 22 wherein the linking control is a visit node.

36. The method of claim 22 wherein the preview includes layout and content of the target resource page.

37. The method of claim 36 further comprising:
displaying the preview in a scaled down browser window.

38. The method of claim 22 wherein the detecting operation comprises:
detecting a cursor hovering over the linking control for a predetermined period of time.

39. The method of claim 22 wherein the retrieving operation comprises:
retrieving the preview content from an archive storage of one or more previously visited resource pages.

40. The method of claim 22 wherein the displaying operation comprises:
highlighting one or more aspects of the preview based on a previous search query.

41. The method of claim 22 wherein the displaying operation comprises
highlighting one or more terms displayed in the preview based on a previous search query.

42. The method of claim 22 wherein the displaying operation comprises:
highlighting one or more aspects of the preview based on a user defined topic.

43. A hyperlink preview utility for previewing a target resource page associated with a linking control, the hyperlink preview utility comprising:
an event monitor detecting a preview invocation event associated with the linking control;
a resource page downloader retrieving preview content of the target resource page associated with the linking control; and
a preview module displaying a preview of the target resource page adjacent to the linking control.

44. The hyperlink preview utility of claim 43 wherein the preview module highlights one or more aspects of the preview based on a previous search query.

45. The hyperlink preview utility of claim 43 wherein the preview module highlights one or more terms displayed in the preview based on a previous search query.

46. The hyperlink preview utility of claim 43 wherein the preview module highlights one or more aspects of the preview based on a user defined topic.
